(19) United States
(12) Patent Application Publication
(10) Pub. No.: US 2010/0141002 A1
(43) Pub. Date: Jun. 10, 2010

(54) BIASING MECHANISM

(76) Inventors: ANDREW J. KURRASCH, Saugatuck, MI (US); Andrew Squires, Grandvilee, MI (US); John F. Aldrich, Grandville, MI (US)

Correspondence Address: BRINKS HOFER GILSON & LIONE, P.O. BOX 10395, CHICAGO, IL, 60610, US

(21) Appl. No.: 12/476,587

(22) Filed: Jun. 2, 2009

Related U.S. Application Data
(60) Provisional application No. 61/058,779, filed on Jun. 4, 2008.

(51) Int. Cl. A47C 1/024; A47C 3/00; B23P 11/00

(52) U.S. Cl. 297/300.1; 29/428

(57) ABSTRACT

A biasing mechanism between two portions of a chair, such as the seat and back components, where the biasing mechanism can position the back component in an infinite number of recline positions between a first, or fully upright, position and a second, or fully reclined, position, where the biasing mechanism consists of a leaf spring and a cylinder in a parallel configuration.

This application claims the benefit of U.S. Provisional Application No. 61/058,779, filed Jun. 4, 2008, the entire disclosure of which is hereby incorporated herein by reference.

### FIELD OF THE INVENTION

The present invention relates to a biasing mechanism, and in particular a biasing mechanism for use with a seating structure.

### BACKGROUND

Seating structures, such as chairs in work place settings, such as offices or in hospitals, are often configured to allow the tiling of the back relative to the seat to allow a user to adjust the seating structure to the user's comfort. Often, a chair has two basic components, a seat component and a back component, and in some instances, the back and seat components are linked together by a mechanical assembly which allows the back to recline with respect to the seat component. The mechanical assembly often includes a spring that biases one or both of a seat or back to an upright position. The mechanical assembly may also include a tilt lock, which permits the seat and/or back to be secured in one or more reclined positions. Typically, the tilt lock is configured as a detent system providing a discrete number of recline positions.

### BRIEF SUMMARY

In one embodiment, the chair assembly includes a base, a support structure pivotally coupled with the base and configured to pivot between a first and second position, where a fulcrum and leaf spring are coupled with the base, where the leaf spring extends longitudinally within the base and comprises a first end engaging the base and a second end biasing the support structure in an upward direction, where the leaf spring is engaged by the fulcrum member in a location between the first and second ends; the chair assembly also includes a cylinder extending longitudinally within the base and coupled between the base and the support structure, where the cylinder is configured to lock the support structure in at least one position between the first and second positions.

In another embodiment, the chair assembly comprises a base, a support structure pivotally coupled with the base at a coupling point which is configured to pivot between a first position and a second position, a retention member coupled with the support structure, a fulcrum member coupled with the base, a stop member coupled with the base, where the support structure is in contact with the stop member when in the first position, a leaf spring extending longitudinally within the base and having a first end engaging the base and a second end disposed below the retention member and biasing the support structure in an upward direction, where the leaf spring is engaged by the fulcrum member between the first and second ends, and a cylinder extending longitudinally within the base and disposed below the leaf spring where the cylinder is coupled between the base and the support structure, and is configured to lock the support structure in at least one position between the first and second positions.

In yet another embodiment, the chair assembly comprises a base, a support structure pivotally coupled with the base at a coupling point and configured to pivot between a first position and a second position, biasing means for biasing the support structure in an upward direction and locking means to lock the support structure in a position between the first position and the second position.

In yet another embodiment, a method of use of the chair assembly includes providing a base pivotally coupled with a support structure, wherein a leaf spring and cylinder are engaged with the base and support structure, and where the support structure is configured to pivot between a first position and a second position, biasing the support structure in an upward direction by bending the leaf spring and compressing the cylinder, applying a load to the support structure in a downward direction, pivoting the support structure in a downward direction, and locking the support structure with respect to the base by engaging the cylinder.

In yet another embodiment, a method of assembly for a chair includes providing a base, a body support having a retention member, and a leaf spring, coupling the leaf spring with the base, coupling the body support with the base such that the body support is disposed substantially above the base, positioning the leaf spring below the retention member, rotating the body support to bias the leaf spring to a first position, inserting a stop member within the base, releasing the body support member, and allowing the body support member to engage the stop member.

### BRIEF DESCRIPTION OF THE DRAWINGS

FIG. 1 is a perspective view of one embodiment of a chair.

FIG. 2 is an exploded view of one embodiment of the chair.

FIG. 3 is a perspective view of one embodiment of the biasing mechanism of the chair.

FIG. 4 fragmentary view of one embodiment of the biasing mechanism of the chair.

FIG. 5 is another fragmentary view of one embodiment of the biasing mechanism of the chair.

FIG. 6 is a perspective fragmentary view of one embodiment of the biasing mechanism of the chair.

FIG. 7 is a bottom view of one embodiment of the biasing mechanism of the chair.

FIG. 8 is a perspective fragmentary view of the leaf spring of the biasing mechanism of the chair

FIG. 9 is a perspective fragmentary view of the cylinder of the biasing mechanism of the chair.

### DETAILED DESCRIPTION OF THE PRESENTLY PREFERRED EMBODIMENTS

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

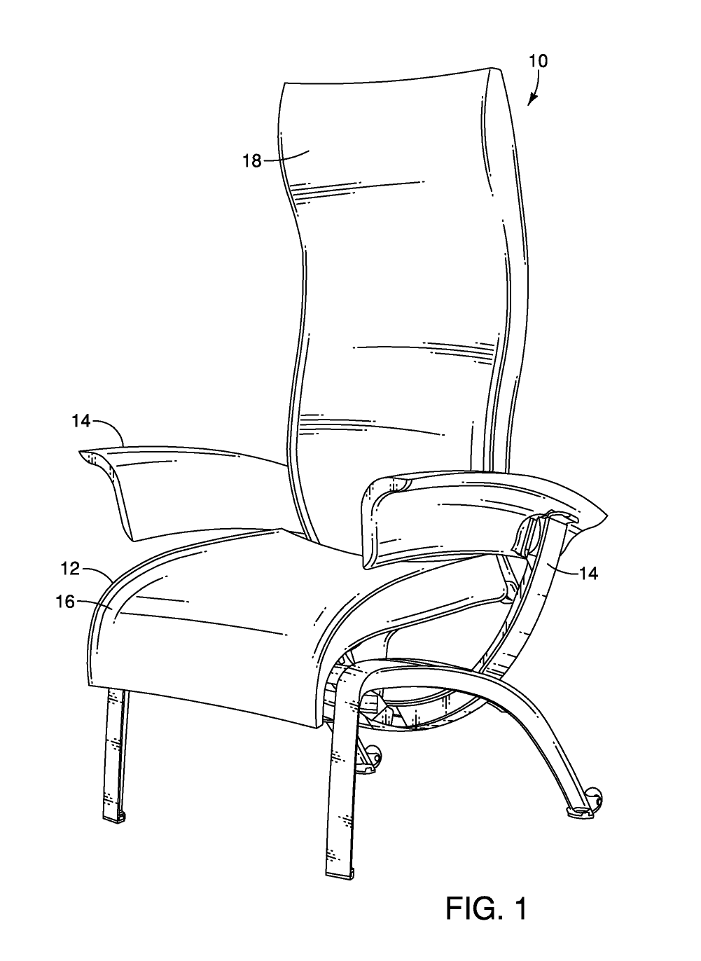

The terms “longitudinal” and “lateral” as used herein are intended to indicate the direction of the chair from front to back and from side to side, respectively. Similarly, the terms “front”, “side”, “back”, “forwardly”, “rearwardly”, “upwardly”, and “downwardly” as used herein are intended to indicate the various directions and portions of the chair as normally understood when viewed from the perspective view of a user sitting in the chair, as shown in FIG. 1.

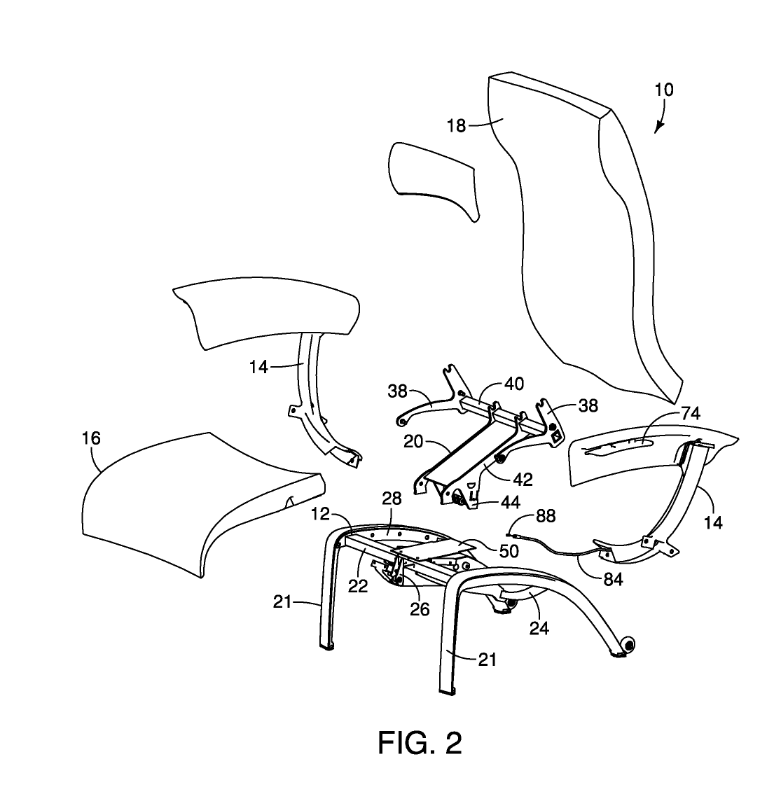

Referring to the drawings, FIG. 1 shows one preferred embodiment of a chair 10 having a base 12 with arm members 14 extending therefrom. The base 12 supports a seat 16, which can include a cushion, a shell, a suspension system, or combinations thereof. A back 18 is disposed adjacent to the seat 16 and base 12, which can also include a cushion, a shell, a suspension system, or combinations thereof. As better seen in FIG. 2, a support structure 20 supports the back 18 and is pivotally coupled with the base 12.

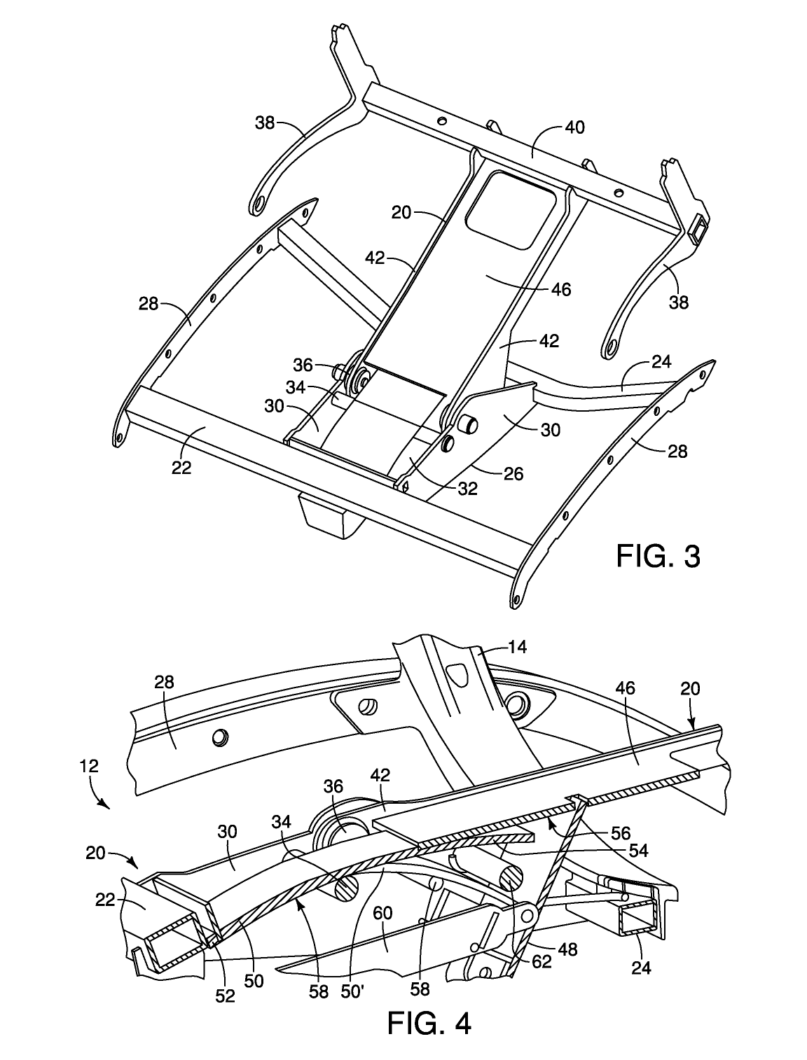

The base 12, as seen in FIG. 2, is coupled to a pair of generally “U” shaped legs 21, spaced apart by a laterally extending front cross member 22 and a rear cross member 24. The arm members 14 are coupled with the legs 21, the base 12 and with each other. A pair of longitudinally extending frame members 28 are connected with the front and rear cross members 22, 24 and form the base 12. The base 12 further includes a tilt control housing or receiving unit 26 with a first end coupled with the front cross member 22 and the second end coupled with the rear cross member 24. The tilt control housing 26 extends in the longitudinal direction and can be best seen in FIG. 3.

The tilt control housing 26 further includes laterally spaced apart side walls 30, forming a cavity 32 therein. A fulcrum member 34 is disposed across the cavity 32, and in one embodiment is configured with a cylindrical cross section. It should be understood that other cross-sections would also be suitable. The fulcrum member 34 can be composed of any suitable material, including various metals and composite materials, such as fiberglass. A pivot pin 36 is connected to the tilt control housing 26 and is configured to pivotally couple with the support structure 20.

As shown in FIG. 3, the support structure 20 includes a pair of laterally spaced apart arms 38 coupled together by a cross bar 40. The arms 38 extend in the longitudinal direction and are configured to pivotally couple with the seat 16 at a seat coupling point 39 through a mechanical fastener, such as a bolt. The seat 16 can then move with, and pivot about, the support structure 20. A pair of laterally spaced side members 42 are also coupled with the cross bar 40 and extend in the longitudinal direction. As shown in FIG. 2, a stop member portion 44 is disposed or formed at the ends of the laterally spaced side members 42, which are configured as plates in one embodiment. As better seen in FIG. 3, a top member 46, configured in one embodiment as a plate, is also disposed between the arms 38 of the support structure 20, and in this embodiment is coupled between the pair of laterally spaced side members 42. A mounting member 48, configured as a plate in one embodiment, extends downwardly from the top member 46 as shown in FIG. 4. The mounting member 48 also extends in the lateral direction and may also be coupled with the laterally spaced side members 42. The support structure 20 is connected to a back frame portion, which supports the back 18.

The support structure 20 is pivotally coupled to the tilt control housing 26 by a pivot pin 36 at a coupling location. In this configuration, the laterally spaced side members 42 are disposed between the side walls 30 of the tilt control housing 26. However, it is also contemplated that the configuration may be switched, such that the laterally spaced side members 42 could be disposed on the outside of the side walls 30 of the tilt control housing 26. In either configuration, the support structure 20 and the tilt control housing 26 are pivotally coupled together using known coupling techniques, such as the pivot pin 36, so long as the support structure 20 can pivot in an upward and downward direction with respect to the tilt control housing 26.

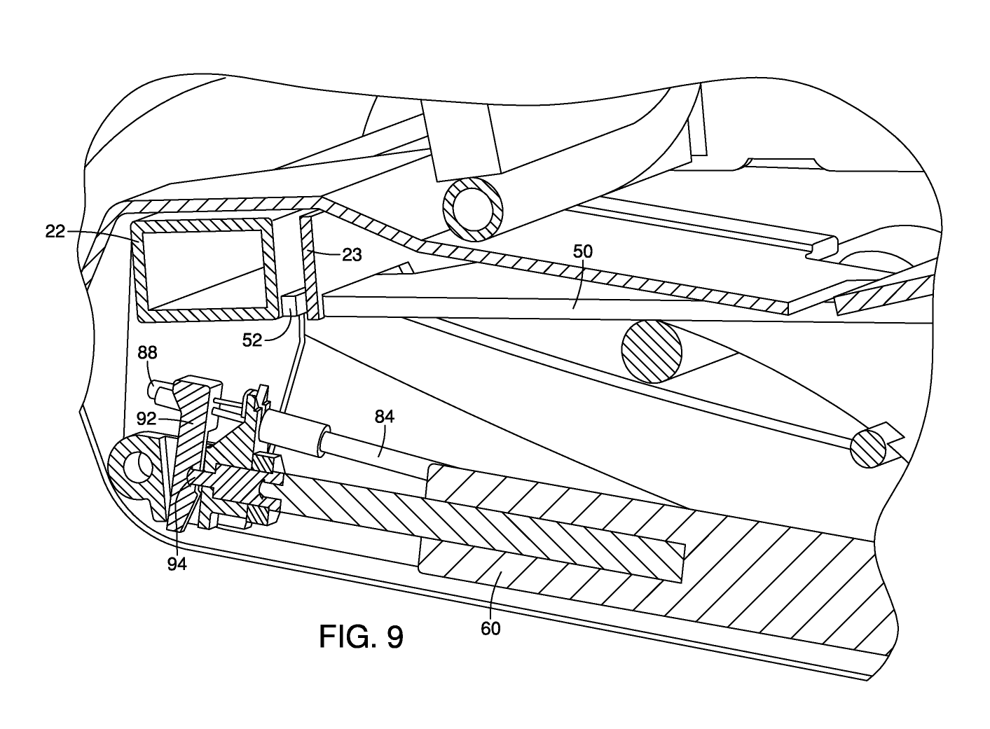

A leaf spring 50 is disposed between the front 22 and rear 24 cross members of the base 12, and has a first end 52 engaged with a securing member 23, such as a bar, which is attached to the front cross member 22, as shown in FIGS. 4 and 9. In this embodiment, the first end 52 of the leaf spring 50 has a securing hole 51 formed therein which is engaged by a locating member, such as a tab extending from the securing member 23. In this way, the first end 52 of the spring 50 is secured to and bears against the securing member 23, but is allowed to pivot relative thereto. In other embodiments, the first end 52 can be fixedly secured in a non-pivoting configuration.

The leaf spring 50 is disposed between the side walls 30 of the tilt control housing 26 and the laterally spaced side members 42. In this embodiment, the leaf spring 50 is confined in the lateral direction by the side walls 30. A second end 54 of the leaf spring 50 extends towards the rear of the chair 10, where the leaf spring 50 is disposed above the fulcrum member 34, and where the second end 54 is disposed below the top member 46 of the support structure 20 as shown in FIG. 4.

A bottom surface 58 of the leaf spring 50 engages the fulcrum member 34, such that the spring 50 bends about the fulcrum member 34. In one embodiment, the second end 54 of the leaf spring 50 is not fixedly coupled with the top member 46 but instead is configured to provide a biasing force against a bottom surface 56 of the top member 46 in the upwardly direction. Accordingly, the second end 54 of the leaf spring 50 is slidable relative to the bottom surface 56 of the top member 46. To facilitate the relationship between these components, the leaf spring 50 and/or the bottom surface 56 may have a coating or be made out of a suitable material providing a lower coefficient of friction between the two components.

In another, alternative, embodiment, also illustrated in FIG. 4, the second end 54 of the leaf spring, denoted as 50′ in this embodiment, is not directly in contact with the top member 46, but is instead disposed below a retention rod 62. The retention rod 62 is coupled to the laterally spaced side members 42, and may be cylindrical in shape. In this embodiment, the second end 54 of the leaf spring 50′ is in contact with the retention rod 62. The biasing force exerted by the leaf spring 50′ is transferred to the support structure 20 through the retention rod 62 and does not act upon the top member 46. Therefore, the design or physical characteristics of the top member 46 may be changed, or it may not be necessary to include the top member 46 at all.

The second end 54 of the leaf spring 50 may also have a wear pad 80 attached thereto, as shown in FIG. 8. The wear pad 80 prevents excessive wear on, and potential damage to, the second end 54 of the leaf spring 50 when in contact with the retention rod 62. The wear pad 80 may be coupled with the second end 54 of the leaf spring 50 through any suitable mechanical attachment mechanism, such as a rivet 82.

The location of the leaf spring 50 may vary. For example, the leaf spring 50 may be disposed laterally outside of the side walls 30, but within the laterally spaced side members 42, or may be disposed outside of both the side walls 30 and body support members 42. In either event, although the leaf spring 50 is shown as a single-leaf, it should also be understood that a plurality of leaf springs could also be employed. The term “plurality” refers to two or more. The leaf springs are preferably made out of a composite material, such as a fiberglass and epoxy matrix, although it should be understood that other resilient materials such as steel would also work. The composite material can be a fibrous composite, a laminated composite or a particulate composite. A suitable composite spring is commercially available form Gordon Plastics, Inc. of Montrose, Colo. under the specification designation of GP68-UD Unidirectional Fiber Reinforced Bar Stock, and sold under the trade name POWER-TUFF. The fiberglass/epoxy matrix bar preferably is unidirectional with a glass content of about 68% and a laminate density of 0.068 lbs./in.³. The bar preferably has a flexstrength of about 135,000 psi, a flex modulus of about 5,000,000 psi, and an ultimate strain of about 2.4%. The use of a composite material bar can help eliminate the problems associated with creep. The leaf spring 50 and mechanism also may be of the types discussed in U.S. Pat. No. 6,250,715, titled CHAIR, filed on Jan. 20, 1999, to Caruso et al., the entire disclosure of which is incorporated by reference herein.

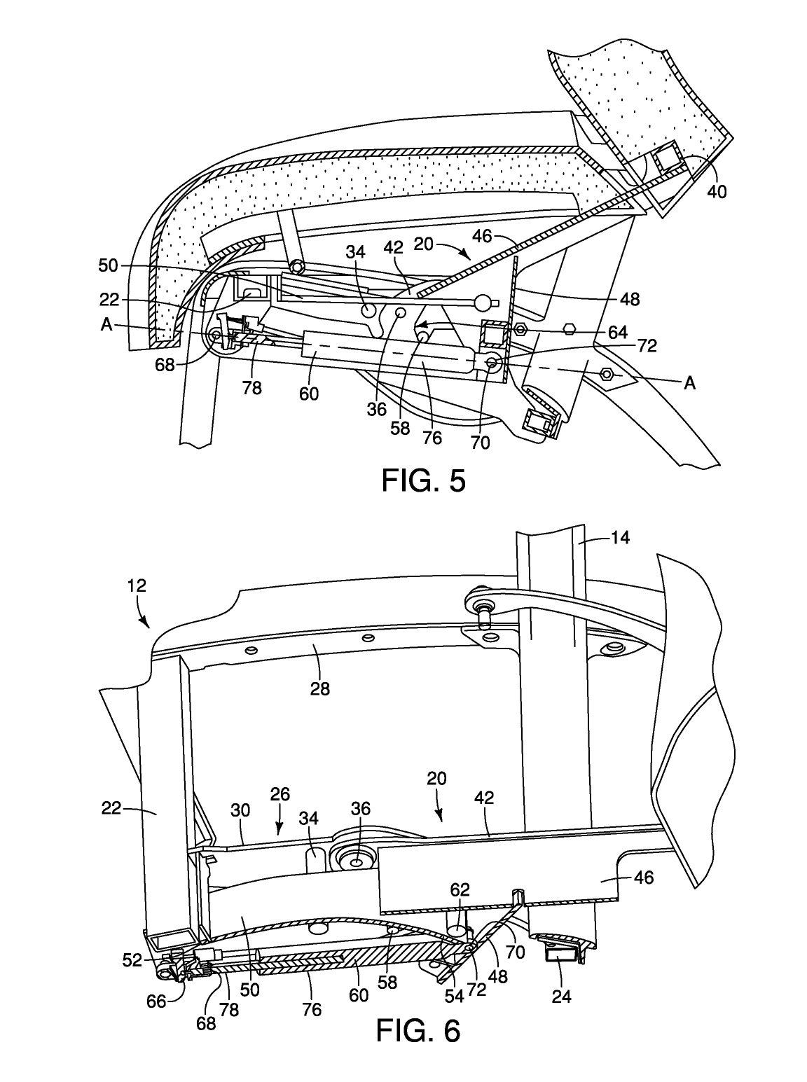

As shown in FIGS. 4 and 5, a stop member 58 is disposed between the side walls 30 of the tilt control housing 26. In this embodiment, the stop member 58 is disposed rearward of the pivot pin 36 and is cylindrical in shape.

Similar to the fulcrum member 34, the stop member 58 can be coupled to the side walls 30 using known mechanical attachment techniques. The stop member 58 is configured to engage the laterally spaced side members 42 to define the forward most position of the support structure 20. The stop member 58 prevents the support structure 20 from pivoting past a certain rotational position. In this embodiment, shown in FIG. 5, the stop member 58 is configured to abut a stop surface 64 of the laterally spaced side members 42. It can be appreciated that the location of the stop member 58 may be varied, as long as the geometry and location of the stop surface 64 of the side members 42 are modified accordingly.

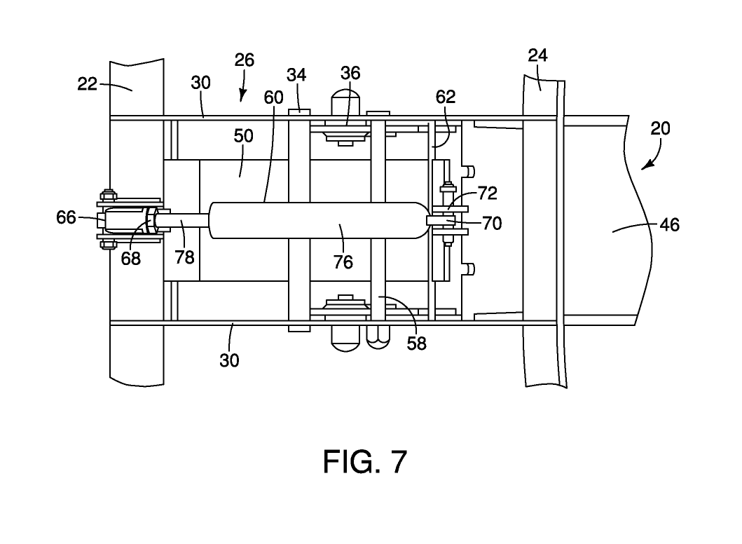

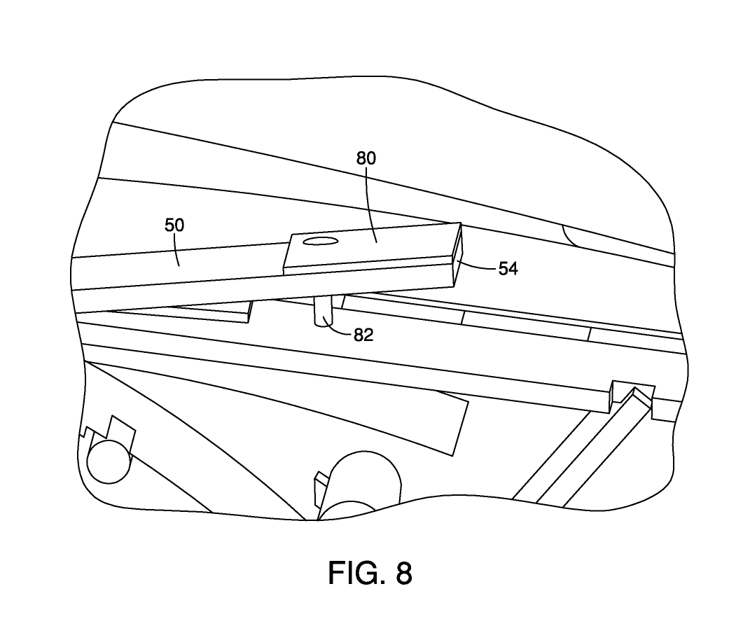

A cylinder 60 or gas spring, shown in FIGS. 5 and 7, is disposed below the leaf spring 50 and between the laterally spaced side members 42 and the side walls 30 of the tilt control housing 26. The cylinder 60 provides a biasing force and a damping force, and allows for an infinite number of locking positions. The cylinder 60 consists of a housing 76 that is adapted to receive a rod 78. The rod 78 is configured to reciprocate within the housing 76. A first end 68 of the rod 78 of the cylinder 60 is pivotably coupled, either directly or through an intermediary front bracket 66, with the front cross member 22 of the base 12. A second end 70 of the housing 76 of the cylinder 60 is coupled with the support structure 20. It can be appreciated that the orientation of the cylinder 60 can be switched, such that the first end 68 is coupled with the support structure 20 and the second end 70 is coupled with the front cross member 22 of the base 12. One suitable cylinder is the BLOC-O-LIFT® gas spring, sold by Stabilus GmbH. The BLOC-O-LIFT® gas spring comprises a dual chamber cylinder, where the chambers are separated by a separation piston. One chamber has another piston slidably disposed therein and is filled with some type of liquid such as oil. The other chamber is filled with a gas, such as Nitrogen. A valve is disposed within the slidable piston that can be actuated to allow the piston to travel within the oil-filled chamber. The valve is connected to a release head 92, via the rod 78. The release head can actuate the valve from an open to a closed position.

In one embodiment, the second end 70 is pivotally coupled with the mounting member 48 through a rear bracket 72. The cylinder 60 is configured to reciprocate along a longitudinal axis A, and can be locked in an infinite number of positions by releasing a release lever 74 shown in FIG. 2 such that it is in a normal at-rest position. The release lever 74 can be actuated to unlock, or release, the cylinder, by pivoting or otherwise moving the release lever to a release position in order to allow the support structure 20 to freely pivot about the tilt control housing 26. In one embodiment, the release lever 74 is spring loaded to pivot or move it to a normal, at-rest lock position from the release position. Although shown as a pivotable member, the release lever 74 can be configured as a push button, toggle member or other known type of actuation member. The release lever 74 is attached to a first end of a cable 84 moveable within a cable guide, as shown in FIG. 2. A second end 88 of the cable 84 is coupled to an actuator extending from one end of the cylinder 60 as shown in FIG. 9. The second end 88 is secured to the release head 92, and is configured to pivot, or move, the release head 92 from a locked to an unlocked position, which corresponds to the locked and unlocked/release position of the release lever 74. The release head 92 in turn is coupled or engaged with an actuator pin 94 of the cylinder 60. The cylinder pin 94 actuates an internal valve to allow the rod 78 of the cylinder 60 to reciprocate along the longitudinal axis A.

In one embodiment, shown in FIGS. 5 and 6, the cylinder 60 is disposed below the leaf spring 50, and in a substantially parallel orientation with the leaf spring 50, along the middle of the tilt control housing 26. The positioning of the cylinder 60 and leaf spring 50 along the centerline of the tilt control housing 26 minimizes the amount of packaging space required to house those components. Additionally, the parallel orientation optimizes the biasing forces created by both components while still keeping the components relatively compact. It can be appreciated, however, that the location of the cylinder 60 with respect to the leaf spring 50 may be varied. For example, the cylinder 60 may be to the side of the spring 50, above the spring 50, below the spring 50, or offset from the spring 50. Indeed, the cylinder 60 may also be disposed on the exterior of the tilt control housing 26 and support structure 20. Moreover, a plurality of cylinders 60 or springs 50 may also be used in a single application.

The upward biasing force exerted on the support structure 20 is created by the leaf spring 50 and the cylinder 60, with approximately 75% of the total biasing force being produced by the leaf spring 50 and 25% being produced by the cylinder 60. Of course, these values may be varied according to the intended application. In this way, the cylinder 60 provides both a biasing force and infinite locking.

In operation, the chair 10 is in a first, or upright position, as shown in FIG. 6. In this position, the stop member 58 is adjacent to, and in contact with, the stop surface 64. The cylinder 60 is in an extended position, with the distance between the first and second ends 66, 68 along the longitudinal axis A being the greatest. The biasing force created by the leaf spring 50 is in the upward direction, so as to thereby support a user sitting in the chair 10. The biasing force produced by the cylinder 60 acts on the rear bracket 72, and consequently creates an upward moment about the pivot pin 36. Since the leaf spring 50 acts on the fulcrum member 34, and the retention rod 62, the top member 46 and other surrounding support structure can be made less robust. The biasing force is referred to as the force created by the cylinder 60 and leaf spring 50.

When the release lever 74 is engaged and a load is applied in the downward direction, the support structure 20 begins to pivot about the tilt control housing 26 in downward direction. The arms 38 of the support structure 20 cause the seat 16 to pivot along with the support structure 20. A front portion of the seat 16 is configured to slide along the side walls 30, or a covering attached thereto, of the tilt control housing 26. It is contemplated that the biasing mechanism may be incorporated into any other seating structure, such that one or both of the seat 16 and back 18 can move relative to each other via a simple pivot, a four link mechanism, a three bar/slide mechanism, or any other known type of tilt systems.

When engaged, the release lever 74 actuates the release head 92 and cylinder pin 94 of the cylinder 60. The actuation of the release head 92 causes the cylinder pin 94 to release an internal valve to allow the cylinder 60 to compress, such that the rod 78 retracts within the housing 76, which causes the distance between the first and second ends 66, 68 along the longitudinal axis A to decrease. The retention rod 62 biases the second end 54 of the leaf spring 50 in the downward direction, which causes the leaf spring 50 to further bend about the fulcrum member 34.

The chair 10 is in the second, or fully reclined position, when the support structure 20 is in its downward most position, where the cylinder 60 is fully compressed, with the distance between the first and second ends 66, 68 at a minimum. The cylinder 60 is adjustable to allow the user or manufacturer to change the maximum degree of recline. When orientated in the maximum degree of recline the leaf spring 50 is substantially bent over the fulcrum member 34.

Alternatively, a stop bar, or plate, may be coupled to the tilt control housing 26, such that the support structure 20 is prevented from further rotating in a downward direction once it comes into contact with the stop bar.

The pivoting movement of the support structure 20, including the retention rod 62 in particular, between the first position and the second position, also causes the retention rod to move relative to the second end 54 of the leaf spring 50.

When the release lever 74 is engaged, and the internal valve of the cylinder 60 is open, the rod 78 may reciprocate along the longitudinal axis A to allow the user to freely move between the first position and the second position. The displacement of the rod 78 also displaces the slidable piston within the oil-filled chamber. The amount of displacement of the rod 78 with respect to the housing 76 is equivalent to the amount of distance the piston travels within the oil-filled chamber. The maximum rate at which the slidable piston reciprocates is governed by the size of the valve and the viscosity of the liquid disposed within the chamber. This creates a damping effect which prevents the piston from moving at an undesired rate, and accordingly governs the maximum rate at which the rod 78 may be displaced. Accordingly, the maximum rate at which the user can freely move between the first position and the second position is governed by the damping created by the cylinder 60.

In the alternative, should the user elect to fix, or lock, the back 18 of the chair relative to the base 12, the user may release the release lever 74 located on one of the arm members 14. The release of the release lever 74 will close the internal valve of the cylinder 60, which will prevent the piston from being further displaced within the oil-filled chamber, and locks the rod 78 with respect to the housing 76. The locking of the rod 78 with respect to the housing 76 also locks the support structure 20 relative to the tilt control housing 26. Because the cylinder 60 does not use a gears or detents to lock the rod 78 relative to the housing 76, the support structure 20 may be locked in an infinite number of rotational positions relative to the tilt control housing 26.

When in the locked position, the non-compressible properties of the oil prevents the piston from being further displaced within the oil-filled chamber. However, the cylinder 60 does have additional spring-like properties if the user elects to “rock” the back portion 18 of the chair towards the second position. The gas-filled chamber is adjacent to the oil-filled chamber. The chambers are separated by a separation piston that can compress the gas-filled chamber when the valve is in the closed position. The non-compressive properties of the oil enable the oil-filled chamber to act upon, and compress the gas-filled chamber when the rod 78 is further extended from the housing 76. Accordingly, if the user exerts the necessary force towards the second position, i.e. the user leans further back, the rod 78 is further extended from the housing 76, which causes the separation piston to compress the gas-filled chamber, creating a biasing force towards the first position.

During assembly, the base 12, tilt control housing 26, fulcrum member 34, and leaf spring 50 are assembled. The support structure 20 is coupled with the tilt control housing 26 at the pivot pin 36. At this stage, the support structure 20 is disposed substantially above the front cross member 22. The second end 54 of the leaf spring 50 is placed below the retention rod 62. The body support member 20 is rotated downwards against the biasing force created by the leaf spring 50. Once the body support member 20 is rotated to a point where it is within its intended range of operation, between the first and second positions, the stop member 58 is inserted and secured to the side walls 30 of the tilt control housing 26. The body support member 20 may then be released, such that the stop member 58 engages the stop member portion 44 of the laterally spaced side members 42. In this orientation the body support member 20 is positioned in the upright, or first position. The cylinder 60 is then coupled between the front cross member 22 and the support structure 20. The arm members 14, seat 16 and back 18, and release lever 74 are then attached to substantially form the chair 10.

The cylinder 60 and leaf spring 50 are positioned in a parallel orientation with respect to one another, as shown in FIG. 7. In the embodiment discussed above, the cylinder 60 and spring 50 are coupled between the base 12 and the tilt control housing 26, however, the cylinder 60 and spring 50 may also be coupled between the base 12 and the seat 16, the base and the back 18, or any two members of the chair 10 which move relative to one another.

Although the present invention has been described with reference to preferred embodiments, those skilled in the art will recognize that changes may be made and formed in detail without departing from the spirit and scope of the invention. It is therefore intended that the foregoing detailed description be regarded as illustrative rather than limiting, and that it be understood that it is the following claims, including all equivalents, that are intended to define the scope of this invention.

What is claimed is:

1. A chair assembly comprising:
a base;
a support structure pivotally coupled with the base and configured to pivot between a first position and a second position;
a fulcrum coupled with the base;
a leaf spring extending longitudinally within the base and comprising a first end engaging the base and a second end biasing the support structure in an upward direction, the leaf spring being engaged by the fulcrum member between the first and second ends; and
a cylinder extending longitudinally within the base and coupled between the base and the support structure, the cylinder being configured to lock the support structure in at least one position between the first and second positions.

2. The chair assembly of claim 1 wherein one of the leaf spring and cylinder is disposed above the other in a substantially parallel orientation.

3. The chair assembly of claim 2 wherein the base and support structure are pivotally coupled at a coupling point, where the fulcrum member is disposed forwardly of the coupling point.

4. The chair assembly of claim 3 wherein the support structure further comprises a stop plate.

5. The chair assembly of claim 4 wherein the base further comprises a stop member.

6. The chair assembly of claim 5 wherein when in the first position the stop plate of the support structure is in contact with the stop member.

7. The chair assembly of claim 6 where the leaf spring is made of a composite material.

8. The chair assembly of claim 7 where a top surface of the leaf spring engages with a bottom surface of the support structure.

9. The chair assembly of claim 7 the support structure further comprising a retention member.

10. The chair assembly of claim 9 where a top surface of the leaf spring engages the retention member.

11. The chair assembly of claim 10 where a back support structure forms part of the support structure.

12. The chair assembly of claim 11 further comprising a pneumatic control configured to lock and unlock the cylinder.

13. The chair assembly of claim 12 where the cylinder provides approximately 25% of the total force biasing the support structure.

14. A chair assembly comprising:
a base;
a support structure pivotally coupled with the base at a coupling point and configured to pivot between a first position and a second position;
a retention member coupled with the support structure;
a fulcrum member coupled with the base;
a stop member coupled with the base, where the support structure is in contact with the stop member when in the first position;
a leaf spring extending longitudinally within the base and with a first end engaging the base and a second end disposed below the retention member and biasing the support structure in an upward direction, the leaf spring being engaged by the fulcrum member between the first and second ends; and
a cylinder extending longitudinally within the base and disposed below the leaf spring, the cylinder coupled between the base and the support structure, the cylinder being configured to lock the support structure in at least one position between the first and second positions.

15. The chair assembly of claim 14 wherein the support structure further comprises a stop surface, where when in the first position, the stop surface is in contact with the stop member.

16. A chair assembly comprising:
a base;
a support structure pivotally coupled with the base at a coupling point and configured to pivot between a first position and a second position;
biasing means for biasing the support structure in an upward direction; and
locking means to lock the support structure in a position between the first position and the second position.

17. The chair assembly of claim 16 further comprising means for positioning the support structure in the first position.

18. A method of use of a chair assembly, the method comprising:
providing a base pivotally coupled with a support structure, wherein a leaf spring and cylinder are engaged with the base and support structure, and where the support structure is configured to pivot between a first position and a second position;
biasing the support structure in an upward direction with the leaf spring and cylinder;
applying a load to the support structure in a downward direction;
pivoting the support structure in a downward direction; and
locking the support structure with respect to the base by engaging the cylinder.

19. The method of claim 18, the method further comprising, unlocking the support structure with respect to the base by disengaging the cylinder.

20. A method of assembly for a chair, the method comprising:
providing a base, a body support having a retention member, and a leaf spring;
coupling the leaf spring with the base;
coupling the body support with the base such that the body support is disposed substantially above the base;
positioning the leaf spring below the retention member;
rotating the body support to bias the leaf spring to a first position;
inserting a stop member within the base;
releasing the body support member; and
allowing the body support member to engage the stop member.

21. The method for assembly of the chair of claim 20 the method further comprising, attaching a cylinder to the base and the support structure.
